(19) United States
(12) Patent Application Publication
(10) Pub. No.: US 2025/0038330 A1
(43) Pub. Date: Jan. 30, 2025

(54) Battery Module

(71) Applicant: LG Energy Solution, Ltd., Seoul (KR)

(72) Inventors: Byeong Jun Jeon, Daejeon (KR); Ji Myong An, Daejeon (KR); Young Su SON, Daejeon (KR)

(73) Assignee: LG Energy Solution, Ltd., Seoul (KR)

(21) Appl. No.: 18/716,646

(22) PCT Filed: Sep. 26, 2023
(86) PCT No.: PCT/KR2023/014808

§ 371 Date: Jun. 5, 2024

(30) Foreign Application Priority Data
Sep. 27, 2022 (KR) 10-2022-0122411

(51) Int. Cl. H01M 50/24; H01M 50/209; H01M 50/258

(52) U.S. Cl. CPC H01M 50/24; H01M 50/209; H01M 50/258

(57) ABSTRACT

Disclosed herein is a battery module including a plurality of battery cells, a cell frame provided with a cell insertion space into which the respective battery cells are inserted, and a support rib dividing the cell insertion space and supporting the respective battery cells. A firewall part in the cell insertion space is provided to surround the respective battery cells. The cell frame is provided so that its thickness becomes thicker at least in part toward the central portion of the cell frame along the insertion direction of the battery cell.

### CROSS-REFERENCE TO RELATED APPLICATIONS

This application is a national phase entry under 35 U.S.C. § 371 of International Application No. PCT/KR2023/014808 filed on Sep. 26, 2023, which claims the benefit of priority based on Korean Patent Application No. 10-2022-0122411 filed on Sep. 27, 2022, the disclosures of which are incorporated herein by reference in their entirety.

### TECHNICAL FIELD

The present invention relates to a battery module, particularly, relates to a battery module for preventing chain ignition, and specifically, relates to a battery module for preventing chain ignition in which a firewall part provided to integrally surround outer peripheral surfaces of a plurality of battery cells can prevent spread of fire.

### BACKGROUND ART

FIGS. 1 and 2 are diagrams for explaining a structure of a conventional battery module.

Referring to FIG. 1, a conventional battery module (10) comprises a lower frame (21), an upper frame (22), and a plurality of battery cells (15).

The lower frame (21) and the upper frame (22) are assembled up and down to form one cell frame (20).

The lower frame (21) is provided with a lower partition wall (25) partitioning an internal space (27) of the lower frame (21) so that one battery cell (15) is insertable. The upper frame (22) has the same structure as the lower frame (21), and is provided with an upper partition wall (26) provided to face the lower partition wall (25).

Each battery cell (15) is inserted into the internal space (27) of the lower frame (21). Next, the upper frame (22) is coupled to the top of the lower frame (21) to cover each battery cell (15).

It is difficult to manufacture the cell frame (20) with a height corresponding to the height of the battery cell (15) through the existing injection process. Accordingly, the cell frame (20) is manufactured separately into two parts of the lower frame (21) and the upper frame (22), which are assembled up and down.

Unless the cell frame (20) is manufactured as a single component, a gap (23) in the cell frame (20) is formed at a joint site between the lower frame (21) and the upper frame (22). Such a gap (23) also exists between the lower partition wall (25) and the upper partition wall (26) disposed to face each other.

The gap (23) has a very narrow interval (G). Even in the case of the very narrow interval (G), if the gap (23) exists, the internal space of the cell frame is connected to enable fluid movement through the gap (23).

If one battery cell (15) of the plurality of battery cells provided in the conventional battery module (10) ignites, the flame may quickly spread from the ignited battery cell (15) to surrounding battery cells through the gap (23).

Generally, the battery cell (15) generates heat upon charging. If the heat generated upon charging or use of the battery cell (15) is not efficiently removed, the battery cell (15) may ignite due to heat accumulation in the battery cell (15).

### DISCLOSURE

### Technical Problem

The present invention is intended to provide a battery module having an integrated cell frame having a vertically symmetrical structure in the longitudinal direction of the battery cell, without constructing a cell frame as a conventional assembly of an upper frame and a lower frame.

In addition, the present invention is intended to provide a battery module capable of preventing spread of fire between adjacent battery cells by manufacturing a cell frame as a one-piece, and filling a firewall part provided to surround the outer peripheral surfaces of the battery cells in the entire inner region of the cell frame.

### Technical Solution

To solve the above-described problem, a battery module according to one example of the present invention comprises a plurality of battery cells, a cell frame provided with a cell insertion space into which the respective battery cells are inserted, and a support rib dividing the cell insertion space and supporting the respective battery cells, and a firewall part provided in the cell insertion space and provided to surround the respective battery cells.

Also, the cell frame is provided so that its thickness becomes thicker at least in part toward the central portion of the cell frame along the insertion direction of the battery cell.

In addition, the cell frame may be provided so that its thickness becomes thicker as it goes from the upper end of the cell frame to the central portion of the cell frame, and may be provided so that its thickness becomes narrower as it goes from the central portion to the lower end of the cell frame, along the insertion direction of the battery cell.

Furthermore, in the cell frame, the cell insertion space may be divided up and down by the support rib, and the upper space of the cell insertion space, which is the top of the support rib, and the lower space of the cell insertion space, which is the bottom of the support rib, may be connected to each other to enable fluid movement.

Also, the cell frame may have a shape that the upper space and the lower space are symmetrical to each other based on the support rib.

In addition, the firewall part may comprise a potting resin, in which it is injected into the cell insertion space and cured to be in a state of surrounding the respective battery cells.

Furthermore, the potting resin may be injected into the entire region of the cell insertion space.

Also, the potting resin may comprise any one of a silicone-based resin, a urethane-based resin, or an epoxy-based resin.

In addition, the firewall part may contact the inner surface of the cell insertion space and the outer peripheral surface of each battery cell, respectively, and may be disposed to divide adjacent battery cells.

Furthermore, the firewall part may be provided so that the width between the inner surface of the cell frame and the battery cell closest to the cell frame becomes narrower as it goes from the upper end of the firewall part to the central portion along the insertion direction of the battery cell, and may be provided so that it becomes wider as it goes from the central portion of the firewall part to the lower end of the firewall part.

Also, the support rib may have a plurality of rib holes into which the respective battery cells are inserted.

In addition, the support rib may be formed integrally with the cell frame.

Furthermore, the support rib may be disposed to be spaced apart along the peripheries of the rib holes, and may comprise a plurality of support protrusions provided to support the side surfaces of the battery cells inserted into the rib holes.

Also, the support protrusion may be formed to protrude from at least one of the top or the bottom of the support rib.

The battery module may further comprise a support pillar passing through the support rib up and down, disposed in parallel with the battery cell, and coupled to the support rib.

In addition, the battery module may further comprise an upper cover mounted on the top of the support pillar and coupled to the cell frame to cover the open top of the cell frame, and a lower cover mounted on the bottom of the support pillar and coupled to the cell frame to cover the open bottom of the cell frame.

### Advantageous Effects

As discussed above, the battery module related to one example of the present invention has the following effects.

Unlike a conventional cell frame composed of an assembly of an upper frame and a lower frame, in the present invention, the cell frame is manufactured as an integrated type in the insertion direction of the battery cell (or ‘cell frame height direction’).

Also, it can be manufactured as a one-piece having a vertically symmetrical structure based on the central portion of the cell frame, and the firewall part filled in the inner side space of the cell frame to surround the respective battery cells can prevent spread of fire between the battery cells.

In addition, due to a structural feature of the integrally formed cell frame, the thickness of the cell frame is provided to become smaller as it goes from the center of the cell frame toward the upper end and the lower end, whereby the firewall part can be formed to have a thicker thickness, and as a result, it is possible to effectively prevent spread of fire between the battery cells.

The conventional battery module has a structure in which the upper and lower frames constituting the cell frame are coupled up and down, and thus after assembling, a gap is created between the upper and lower frames, whereas the present invention can integrally form the firewall part by inserting a plurality of battery cells into the integrated cell frame, and then injecting a flame-retardant material into the cell insertion space of the cell frame to be cured.

### DESCRIPTION OF DRAWINGS

FIGS. 1 and 2 are schematic drawings showing a structure of a conventional battery module.

FIG. 3 schematically shows a cross-sectional diagram of a battery module according to an embodiment of the present disclosure.

FIG. 4 schematically shows a perspective diagram of a cell frame according to an embodiment of the present disclosure.

FIG. 5 schematically shows a cross-sectional diagram of a cell frame according to an embodiment of the present disclosure.

FIG. 6 is a schematic view showing insertion of a battery cell into a cell insertion space of a cell frame according to an embodiment of the present disclosure.

FIG. 7 is a schematic view of battery cells inserted into a cell frame according to an embodiment of the present disclosure.

FIG. 8 is a schematic view of a structure of a firewall part in a cell insertion space of a cell frame according to an embodiment of the present disclosure.

FIG. 9 is a schematic view of an upper cover and a lower cover coupled to a cell frame according to an embodiment of the present disclosure.

### BEST MODE

Hereinafter, a battery module according to one example of the present invention will be described in detail with reference to the attached drawings.

In addition, regardless of the reference numerals, the same or corresponding components are given by the same or similar reference numerals, duplicate descriptions thereof will be omitted, and for convenience of explanation, the size and shape of each component member as shown can be exaggerated or reduced.

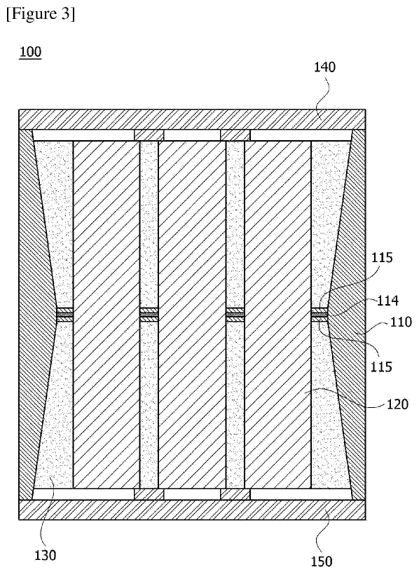

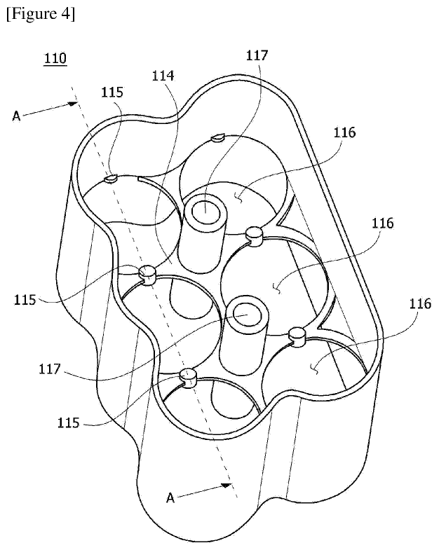

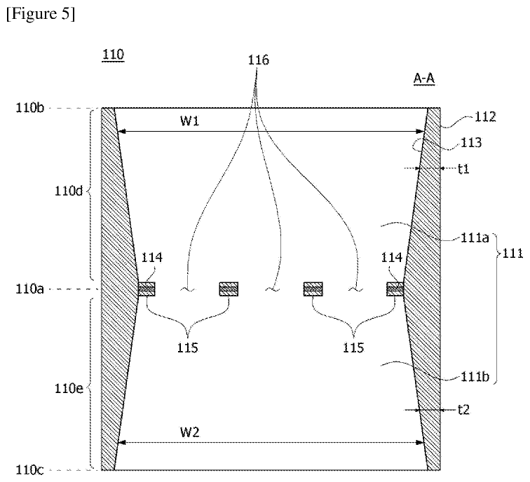

FIG. 3 schematically shows a cross-sectional diagram of a battery module (100) according to one example of the present invention, FIG. 4 schematically shows a perspective diagram of a cell frame according to one example of the present invention, and FIG. 5 schematically shows a cross-sectional diagram of a cell frame according to one example of the present invention.

Referring to FIG. 3, the battery module (100) according to one example of the present invention comprises a cell frame (110), a plurality of battery cells (120), and a firewall part (130).

In addition, each battery cell (120) may be a cylindrical battery.

Specifically, the battery module (100) according to one example of the present invention comprises a plurality of battery cells (120), a cell frame (110) provided with a cell insertion space (111) into which the respective battery cells (120) are inserted, and a support rib (114) dividing the cell insertion space (111) and supporting the respective battery cells (120), and a firewall part (130) provided in the cell insertion space (111) and provided to surround the respective battery cells.

Referring to FIGS. 4 and 5, the cell frame (110) is a case for accommodating a plurality of battery cells (120). The cell frame (110) is provided with a cell insertion space (111) and a support rib (114). The cell insertion space (111) is a space where the plurality of battery cells (120) is inserted.

In the cell frame (110), the top and the bottom may each be opened.

In the cell frame (110), the cell insertion space (111) is divided up and down by the support rib (114). In this instance, the upper space (111a) of the cell insertion space (111), which is the top of the support rib (114), and the lower space (111b) of the cell insertion space (111), which is the bottom of the support rib (114), may be connected to each other to enable fluid movement. In addition, the upper space (111a) and the lower space (111b) may be provided to be vertically symmetrical based on the support rib (114).

For example, the cell frame (110) may have a shape that the upper space (111a) and the lower space (111b) are symmetrical to each other based on the support rib (114). In addition, the support rib (114) may be formed integrally with the cell frame (110).

In FIG. 3, the x-axis direction represents the arrangement direction of the plurality of battery cells (120) disposed in the cell frame (110) or the radial direction of the battery cells (120). Then, the y-axis direction represents the insertion direction of the battery cells (120) or the height direction of the cell frame (110).

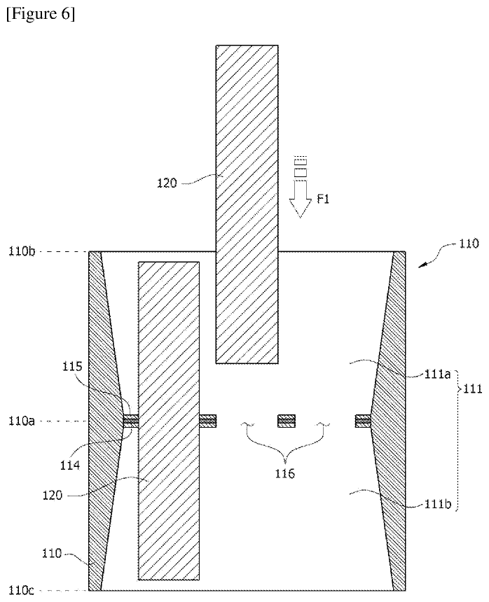

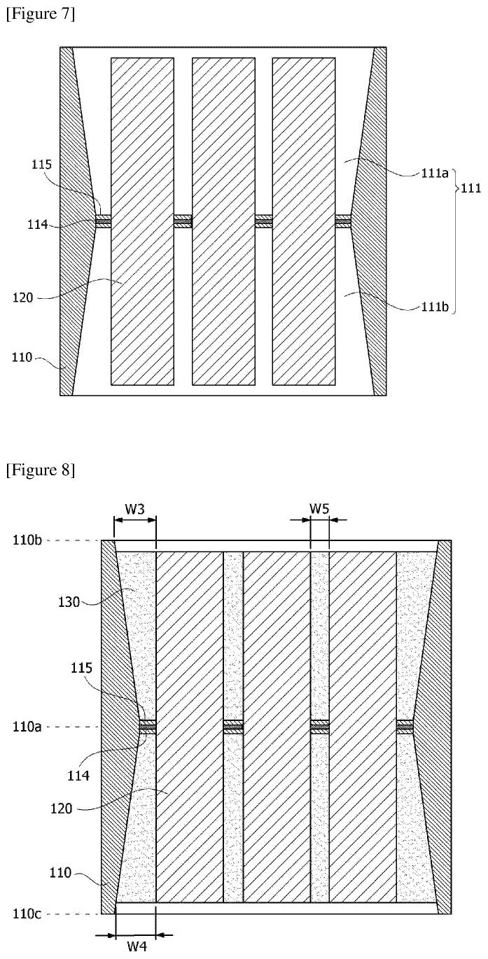

FIG. 6 is a diagram for explaining a process of inserting a battery cell into a cell insertion space of a cell frame according to one example of the present invention, and FIG. 7 is a diagram for explaining a state where battery cells are inserted into a cell frame according to one example of the present invention.

The cell frame (110) may be formed integrally along the height direction. As the cell frame (110) is manufactured as a one-piece, it may be provided so that its thickness (t1) becomes thicker as it goes from the upper end (110b) of the cell frame (110) to the central portion (110a) of the cell frame (110), and may be provided so that its thickness (t2) becomes narrower as it goes from the central portion (110a) to the lower end (110c) of the cell frame, along the insertion direction (F1, see FIG. 6) of the battery cell (120).

Referring to FIGS. 5 and 6, the cell frame (110) is provided so that the width (W1) of the cell insertion space (111) of the cell frame (110) becomes narrower as it goes from the upper end (110b) of the cell frame (110) to the central portion (110a) of the cell frame (110), along the insertion direction (F1) of the battery cell.

That is, the cell frame (110) is provided so that the width (W1) of the upper region (111a) of the cell insertion space (111) becomes narrower as it goes from the upper end (110b) of the cell frame (110) to the central portion (110a) of the cell frame (110).

Also, the upper end portion (110d) of the cell frame (110) is provided so that its thickness (t1) becomes thicker as it goes from the upper end (110b) of the cell frame (110) to the central portion (110a) of the cell frame (110), along the insertion direction (F1) of the battery cell. The thickness (t1) is the gap between the outer surface (112) and the inner surface (113) of the cell frame (110) in the upper end portion (110d) of the cell frame (110).

In addition, the upper end portion (110d) of the cell frame (110) may be provided so that its thickness (t1) becomes thicker at least in part as it goes from the upper end (110b) of the cell frame (110) to the central portion (110a) of the cell frame (110), along the insertion direction (F1) of the battery cell.

Furthermore, the upper end portion (110d) of the cell frame (110) may be provided so that its thickness (t1) becomes thicker continuously as it goes from the upper end (110b) of the cell frame (110) to the central portion (110a) of the cell frame (110), along the insertion direction (F1) of the battery cell.

In addition, the upper end portion (110d) of the cell frame (110) may be provided so that its thickness (t1) becomes thicker linearly as it goes from the upper end (110b) of the cell frame (110) to the central portion (110a) of the cell frame (110), along the insertion direction (F1) of the battery cell.

Here, the upper end portion (110d) of the cell frame refers to the portion where the upper space (111a) is provided. Also, the upper space (111a) may have an approximately inverted trapezoidal cross-section.

In addition, the cell frame (110) may have a shape that the upper space (111a) and the lower space (111b) are symmetrical to each other based on the support rib (114).

The cell frame (110) is provided so that the width (W2) of the cell insertion space (111) becomes wider as it goes from the central portion (110a) of the cell frame (110) to the lower end (110c) of the cell frame (110), along the insertion direction (F1) of the battery cell.

That is, the cell frame (110) is provided so that the width (W2) of the lower space (111b) of the cell insertion space (111) becomes wider as it goes from the central portion (110a) of the cell frame (110) to the lower end (110c) of the cell frame (110), along the insertion direction (F1) of the battery cell.

The lower end portion (110e) of the cell frame is provided so that its thickness (t2) becomes smaller as it goes from the central portion (110a) to the lower end (110c) of the cell frame, along the insertion direction (F1) of the battery cell. The thickness (t2) is the gap between the outer surface (112) and the inner surface (113) of the cell frame (110) in the lower end portion (110e) of the cell frame (110).

Also, the lower end portion (110e) of the cell frame is provided so that its thickness (t2) becomes smaller at least in part as it goes from the central portion (110a) to the lower end (110c) of the cell frame, along the insertion direction (F1) of the battery cell.

In addition, the lower end portion (110e) of the cell frame may be provided so that its thickness (t2) becomes smaller continuously as it goes from the central portion (110a) to the lower end (110c) of the cell frame, along the insertion direction (F1) of the battery cell.

Furthermore, the lower end portion (110e) of the cell frame may be provided so that its thickness (t2) becomes smaller linearly as it goes from the central portion (110a) to the lower end (110c) of the cell frame, along the insertion direction (F1) of the battery cell.

Here, the lower end portion (110e) of the cell frame (110) refers to the portion where the lower space (111b) is provided. In addition, the lower space (111b) may have a trapezoidal cross-section.

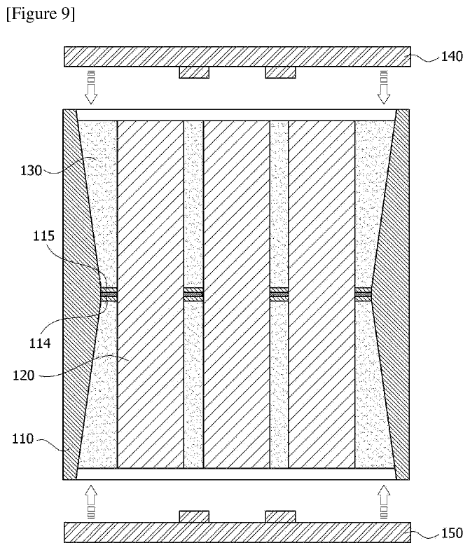

FIG. 8 is a diagram for explaining a structure of a firewall part provided in a cell insertion space of a cell frame, in one example of the present invention, and FIG. 9 is a diagram for explaining a process in which a upper cover and a lower cover are coupled to a cell frame in one example of the present invention.

The firewall part (130) may comprise a potting resin, in which it is injected into the cell insertion space (111) and cured to be in a state of surrounding the respective battery cells.

Also, the firewall part (130) may be formed of a flame-retardant material having flame retardancy. The firewall part (130) is provided to surround the inner surface of the cell insertion space (111) and the outer peripheral surface of each battery cell (120).

In addition, the firewall part (130) contacts the inner surface of the cell insertion space (111) and the outer peripheral surface of each battery cell (120), and is disposed to divide adjacent battery cells (120). That is, the firewall part (130) is formed by being filled in the space between adjacent battery cells (120). In addition, the firewall part (130) is formed by being also filled in the space between the inner surface of the cell frame (110) and the battery cell (120) closest to the cell frame (110).

Furthermore, the firewall part (130) may be formed as the flame-retardant material is injected into the space between the battery cells (120) in the cell insertion space (111) and cured. In addition, the potting resin may be injected into the entire region of the cell insertion space (111).

In this document, the potting resin, in which silicone and a flame retardant are mixed, may be used as the flame-retardant material. In this example, the potting resin may comprise any one of a silicone-based resin, a urethane-based resin, or an epoxy-based resin.

The firewall part (130) contacts the inner surface of the cell insertion space (111) and the outer peripheral surface of each battery cell (120), and divides adjacent battery cells (120).

Referring to FIG. 8, in the upper space (111a), the firewall part (130) is provided so that the width (W3) between the inner surface of the cell frame (110) and the battery cell (120) adjacent to the cell frame (110) becomes narrower as it goes from the upper end (110b) of the cell frame (110) to the central portion (110a).

That is, the firewall part (130) may be provided so that the width (W3) between the inner surface (surface forming the cell insertion space) of the cell frame (110) and the battery cell (120) closest to the cell frame (110) becomes narrower as it goes from the upper end (110b) of the cell frame (110) to the central portion (110a).

Also, the firewall part (130) may be provided so that the width (W4) between the inner surface (113, surface forming the cell insertion space) of the cell frame (110) and the battery cell (120) closest to the cell frame (110) increases as it goes from the central portion (110a) of the cell frame (110) to the lower end (110c) of the cell frame (110) along the insertion direction of the battery cell.

In addition, the firewall part (130) is also disposed in the space between two adjacent battery cells, where the firewall part (130) dividing two battery cells (120) adjacent to each other may be provided so that its thickness (W5) is approximately constant.

Referring to FIGS. 4 and 5, the support rib (114) may have a plurality of rib holes (116) into which the respective battery cells (120) are inserted. In addition, each battery cell (120) is inserted into each rib hole (116).

The support rib (114) is formed integrally with the cell frame (110) to divide the cell insertion space (111) up and down. In addition, the support rib (114) integrally supports the respective battery cells (120) inserted into the cell insertion space (111).

Also, the support rib (114) may be disposed to be spaced apart along the peripheries of the rib holes (116), and may comprise a plurality of support protrusions (115) provided to support the side surfaces of the battery cells (120) inserted into the rib holes (116). As one example, the support protrusion (115) may be formed to protrude from at least one of the top or the bottom of the support rib (114). In addition, the support protrusion (115) may be formed integrally with the support rib (114).

In addition, the support rib (114) may be provided to surround the outer peripheral surface of the battery cell (120) at a predetermined width interval (W5), and two battery cells (120) adjacent to each other may be spaced apart by the width interval (W5). For example, adjacent rib holes (116) may be disposed to be spaced apart from each other to have a predetermined width interval (W5). Furthermore, the firewall part (130) is filled in the space between two adjacent battery cells.

Referring to FIGS. 4 and 5, the support rib (114) is provided in the cell frame (110) to divide the cell insertion space (111) up and down. The support rib (114) supports the side surfaces of the respective battery cells (120), and is provided so that the respective battery cells (120) are disposed to be spaced apart at regular intervals.

The respective battery cells (120) are inserted into the cell insertion space (111) by passing through the respective rib holes (116). The support protrusion (115) may contact the outer peripheral surface of the battery cell (120) to support the side surface of the battery cell (120).

The battery module (100) may comprise a support pillar (117) passing through the support rib (114) up and down, disposed in parallel with the battery cell (120), and coupled to the support rib (114).

The support pillar (117) is coupled to the support rib (114) by penetrating the support rib (114) up and down, is disposed in parallel with the battery cell (120), and supports the support rib (114).

The battery module (100) may comprise an upper cover (140) mounted on the top of the support pillar (117) and coupled to the cell frame (110) to cover the open top of the cell frame, and a lower cover (150) mounted on the bottom of the support pillar (117) and coupled to the cell frame to cover the open bottom of the cell frame (110).

As one example, the upper cover (140) and the lower cover (150) may be fitted and coupled to the support pillar (117).

Referring to FIG. 9, the upper cover (140) may be coupled to the cell frame (110) to cover the open top of the cell frame (110), as it is fitted and coupled to the top of the support pillar (117). In addition, the lower cover (150) may be coupled to the cell frame (110) to cover the open bottom of the cell frame (110), as it is fitted and coupled to the bottom of the support pillar (117).

Hereinafter, the manufacturing method of the battery module configured as above will be described.

Referring to FIGS. 4 and 5, a cell frame (110) provided with a cell insertion space (111) and a support rib (114) is prepared.

Referring to FIG. 6, each battery cell (120) is inserted into the cell insertion space (111) by passing through each rib hole (116).

Referring to FIG. 7, when a plurality of battery cells (120) is inserted into the cell insertion space (111), a flame-retardant material is injected into the cell insertion space (111). As described above, a potting resin, in which silicone and a flame retardant are mixed, may be used as the flame-retardant material. In addition, the potting resin is one of a silicone-based resin, a urethane-based resin, or an epoxy-based resin.

Referring to FIG. 8, while the filled flame-retardant material is cured, a firewall part (130) surrounding the inner surface of the cell insertion space (111) and the outer peripheral surface of each battery cell (120) is formed.

The firewall part (130) is in contact with the inner surface of the cell insertion space (111) and the outer peripheral surface of each battery cell (120), respectively, and surrounds each battery cell (120) in the cell insertion space (111), and the firewall part (1130) forms firewalls in which adjacent battery cells (120) divide each other.

Referring to FIG. 9, the upper cover (140) is fitted and coupled to the top of the support pillar (117) to cover the open top of the cell frame (110), and the lower cover (150) is fitted and coupled to the bottom of the support pillar (117) to cover the open bottom of the cell frame (110).

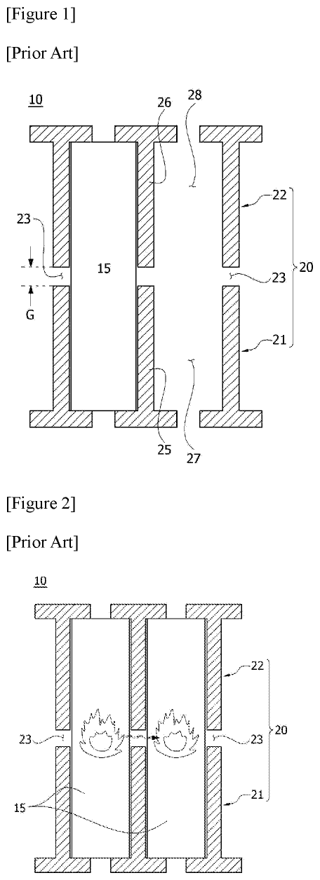

Also, as the cell frame (110) is manufactured as a one-piece, there is no joint site of the cell frame (110), and there is no gap (G, see FIG. 1) due to the joint site.

In addition, the firewall part (130) is filled in the entire region of the cell insertion space (111) and cured, and thus is provided to surround each battery cell (120), thereby blocking the flame of the ignited battery cell from transferring to surrounding battery cells, whereby it is possible to prevent chain ignition of battery cells.

The preferred examples of the present invention as described above have been disclosed for illustrative purposes, and those skilled in the art having ordinary knowledge of the present invention will be able to make various modifications, changes, and additions within the spirit and scope of the present invention, and such modifications, changes, and additions should be regarded as falling within the scope of the following claims.

1. A battery module comprising:
a plurality of battery cells;
a cell frame provided with a cell insertion space into which the respective battery cells are inserted, and a support rib dividing the cell insertion space and supporting the respective battery cells; and
a firewall part provided in the cell insertion space and provided to surround the respective battery cells, wherein
the cell frame is provided so that its thickness becomes thicker at least in part toward the central portion of the cell frame along the insertion direction of the battery cell.

2. The battery module according to claim 1, wherein
the cell frame is provided so that its thickness becomes thicker as it goes from the upper end of the cell frame to the central portion of the cell frame, and is provided so that its thickness becomes narrower as it goes from the central portion to the lower end of the cell frame, along the insertion direction of the battery cell.

3. The battery module according to claim 1, wherein
in the cell frame, the cell insertion space is divided up and down by the support rib, and the upper space of the cell insertion space, which is the top of the support rib, and the lower space of the cell insertion space, which is the bottom of the support rib, are connected to each other to enable fluid movement.

4. The battery module according to claim 1, wherein
the cell frame has a shape that the upper space and the lower space are symmetrical to each other based on the support rib.

5. The battery module according to claim 1, wherein
the firewall part comprises a potting resin, in which it is injected into the cell insertion space and cured to be in a state of surrounding the respective battery cells.

6. The battery module according to claim 5, wherein
the potting resin is injected into the entire region of the cell insertion space.

7. The battery module according to claim 6, wherein
the potting resin comprises any one of a silicone-based resin, a urethane-based resin, or an epoxy-based resin.

8. The battery module according to claim 1, wherein
the firewall part contacts the inner surface of the cell insertion space and the outer peripheral surface of each battery cell, respectively, and is disposed to divide adjacent battery cells.

9. The battery module according to claim 8, wherein
the firewall part is provided so that the width between the inner surface of the cell frame and the battery cell closest to the cell frame becomes narrower as it goes from the upper end of the firewall part to the central portion along the insertion direction of the battery cell, and is provided so that it becomes wider as it goes from the central portion of the firewall part to the lower end of the firewall part.

10. The battery module according to claim 1, wherein
the support rib has a plurality of rib holes into which the respective battery cells are inserted.

11. The battery module according to claim 10, wherein
the support rib is formed integrally with the cell frame.

12. The battery module according to claim 10, wherein
the support rib is disposed to be spaced apart along the peripheries of the rib holes, and comprises a plurality of support protrusions provided to support the side surfaces of the battery cells inserted into the rib holes.

13. The battery module according to claim 12, wherein
the support protrusion is formed to protrude from at least one of the top or the bottom of the support rib.

14. The battery module according to claim 1, further comprising
a support pillar passing through the support rib up and down, disposed in parallel with the battery cell, and coupled to the support rib.

15. The battery module according to claim 14, further comprising:
an upper cover mounted on the top of the support pillar and coupled to the cell frame to cover the open top of the cell frame; and
a lower cover mounted on the bottom of the support pillar and coupled to the cell frame to cover the open bottom of the cell frame.
